(19) United States
(12) Patent Application Publication
(10) Pub. No.: US 2017/0063549 A1
(43) Pub. Date: Mar. 2, 2017

(54) Portable Biometric-based Identity Device

(71) Applicant: HANSCAN IP B.V., Ouderkerk aaan de Amstel (NL)

(72) Inventors: Klaas ZWART, Ouderkerk aaan de Amstel (NL); Nicolas ANTEQUERA RODRIGUEZ, Ouderkerk aaan de Amstel (NL)

(73) Assignee: HANSCAN IP B.V., Ouderkerk aaan de Amstel (NL)

(21) Appl. No.: 15/120,184

(22) PCT Filed: Feb. 23, 2015
(86) PCT No.: PCT/EP2015/053740

§ 371 Date: Aug. 19, 2016

(30) Foreign Application Priority Data
Feb. 24, 2014 (ES) 201430247

(51) Int. Cl. H04L 9/32; G06K 9/00; H04W 12/02; H04L 9/08; H04L 29/06

(52) U.S. Cl. CPC H04L 9/3231; H04L 9/0869; H04L 63/0428; H04W 12/02; G06K 9/00906

(57) ABSTRACT

A portable biometric device and system for secure communication and method for operating said system. The invention describes a portable biometric device (1) designed for improving security during internet transactions by means of a gateway device (20). Also described is a secure actuation device (40) which, together with the portable biometric device (1), allows the opening or closing of a set of access control elements in facilities to be controlled in order to block the entry of unauthorised persons. Also described are two systems for secure communication, which respectively comprise a portable biometric device (1) and a secure actuation device (40) combined with a portable biometric device (1), and methods for operating said systems.

### TECHNICAL FIELD OF THE INVENTION

Portable biometric device and system for secure communication and method for operating said system.

### BACKGROUND OF THE INVENTION

Currently, the internet is used to carry out a large number of different operations, which may include purchases, bank transactions, and administrative tasks, etc. Many of these operations require sensitive information to be sent or received by the user, for example information relating to the user's personal details, their bank data, etc., for which reason it is essential to be able to rely on the security mechanisms that block unauthorised persons from accessing such data.

Banks tend to use a security mechanism based on the existence of a first personal key for general access to the page displaying the user's data, in combination with the request for one or more codes which are associated with a particular operation and have been sent to the user beforehand from a server of the bank via the user's mobile phone. However, this mechanism has the drawback that it may be possible for a third party to carry out operations without the user's authorisation by simply accessing the user's personal access key and mobile phone.

In short, the need for security mechanisms that allow users to exchange sensitive data within a network such as the internet in a quick, secure and simple manner is ever present. WO-2012/140291 (with common inventorship) discloses a device for biometric identification. This device directly communicates acquired biometric information over unsecured networks and therefore has limited applications.

### SUMMARY OF THE INVENTION

The present invention belongs to the field of security mechanisms used for sending sensitive information over the internet.

The present invention relates to a novel portable biometric device which is designed such that the user carries it with him at all times and which allows both the user to be biometrically identified and information, which said device exchanges with the outside, to be encrypted/decrypted.

The invention also relates to a novel secure actuation device for controlling the opening of doors and similar elements for controlling access to facilities for the sole purpose of preventing unauthorised persons from entering.

The invention is further directed to systems which respectively include the above-mentioned portable biometric device and the secure actuation device in combination with the portable biometric device, and to the respective operating methods for both systems.

The present invention solves the problem of the prior art by means of a novel portable biometric device which not only unmistakeably identifies a user, seeking to exchange information over the internet, by means of their biometric data, but also establishes a secure communication path via which said device exchanges the encrypted information with the destination server for the communication. The device according to the invention can also communicate directly, also once the information is encrypted, with an actuation device which is specifically designed for opening and closing various security elements. This device allows operations to be carried out which require an increased level of security in terms of both the information exchanged, e.g. carrying out electronic banking operations, and the identity of the user, e.g. to open doors in restricted access areas.

The portable biometric device according to the invention is specifically designed to communicate with the outside by means of a device referred to as a “gateway device”. The gateway device can be a smartphone, a laptop, a tablet, a personal computer, and generally any electronic device that allows the user to exchange information over the internet. The portable biometric device according to the invention is used to check the identity of the user seeking to exchange the information or to open/close a security element, thus blocking the entry of unauthorised users. In addition, the above-mentioned portable biometric device encrypts the sent information to prevent third parties from gaining access thereto for malicious purposes.

A first aspect of the present invention is directed to a portable biometric device for secure communication in accordance with the present invention, basically comprising the following elements: a biometric sensor, life detection means, physical security means, a processing means, a secure memory unit, and a communication unit.

a) Biometric Acquisition Sensor

The biometric acquisition sensor is used to acquire the biometric data of a user seeking to exchange sensitive information on the internet via the gateway device. In principle, it is possible to use any type of biometric sensor capable of unambiguously identifying the user. For example, in a preferred embodiment of the invention, the biometric sensor is a digital fingerprint reader. The biometric acquisition sensor may be configured to acquire the biometric data by means of a swiping motion, for example of a thumb and/or another finger and this may be a separate aspect of the invention.

The biometric acquisition sensor is in communication with the processor, which will be described below. This communication can take place by means of a serial protocol for transmitting the acquired biometric data to the processing means.

b) Life Detection Sensor

The life detection sensor comprises one or more sensors for determining that the user whose biometric data are being acquired is alive, thus preventing a third party from identifying themselves using for example plastic moulds or even amputated parts of said authorised user to fraudulently obtain the user's confidential information or to control security elements.

In principle, the life detection sensor can include various types of sensors, although, in accordance with a preferred embodiment of the invention, said sensor comprises one or more of: a pulse detector; a blood oxygen detector; and a neural sensor.

In this particular case, such a life detection sensor in turn comprises:
i) a set of near infrared LEDs and a photodiode for receiving the light that has passed through a translucent portion of the user's body, such as a finger,
ii) a filtering module having a bandwidth of between 0.1 and 20 Hz for eliminating unnecessary noise and to ensure measurements of between 30 and 300 beats per minute,
iii) a signal amplification module having a gain of between 100 and 1000,
iv) a control and signal conditioning logic.

The life detection sensor is in communication with the processor. This communication can take place by means of a 12-bit A/D converter for transmitting the acquired data to the processing means.

c) Physical Security Component

The physical security component typically comprises a plurality of microswitches that detect possible deformations in an outer shell of the portable biometric device according to the invention as a result of tampering. These microswitches cause an alarm to be triggered if they detect movements, owing to the twisting or bending of the shell, which are not compatible with the normal use of the portable biometric device.

In another preferred embodiment, the shell of the portable biometric device is completely filled with cured epoxy resin, making any tampering of the electronic components therein extremely difficult.

d) A Processor

The processor is in communication with the biometric acquisition sensor, the life detection sensor and the physical security component, and is designed to encrypt operating data (which may be input by the user or it may be intrinsic to the device) and/or the biometric information, (and optionally the pulse and/or the blood oxygen and/or neural data obtained from the user), before this information (or at least part of this information) is sent externally, and to decrypt the incoming information.

Preferably, the portable biometric device is formed as a single, integrated device, such that its component features may be inseparable. For example, this may be a single integrated circuit (such as an Application Specific Integrated Circuit, ASIC). This integration may further prevent tampering.

The portable biometric device can replace a range of identification items. These may include passport, identity document, licences, keys, passwords, credit cards, swipe cards, holograms, remote controls, car fobs, access codes, digital certificates and in general, all unprotected biometrics such as fingerprints, footprints veins, iris, facial recognition, voice recognition, remote controls, credit cards, digital certificates, PIN numbers, etc.

The encryption operation is complex and in summary, basically comprises the following steps:
i) generating path sequences, which are variable in time, of a table of keys, which are generated in a random manner, for determining a key selected by means of a path descriptor;
ii) generating a random seed for defining an initial state of the path descriptor; and
iii) executing an encryption/decryption algorithm on said random seed and said information, which algorithm includes a bitwise XOR operation with said selected key.

In the following, the encryption operation and the functional means that the processing means comprises will be described in greater detail. For said operation, use is made of an encryption/decryption unit which includes an input/output for both biometric data and general data corresponding to the parameters required for the communication, such as time stamps and the packet number, through which input/output the information as generated M (unencrypted message) and the information after being encrypted M′ (encrypted message) respectively pass. Said unit also includes a central processing unit (CPU), a real-time clock RTC and an internal memory of the ROM-Flash type, which is secured such as to block electronic attacks related to a transient signal change in order to prevent access to the content of said memory and is intended for storing the table of keys that is in use at that moment.

Preferably, the list or table of keys is integrated by in numbers of n randomly generated bits. The key path sequence is obtained from a linear feedback shift register (LFSR) of k stages (each stage corresponds to a one bit logical bistable), having 2k more than or equal to in and a filter function B of order j thereof defined by a Boolean function which generates, as an output, numbers between 1 and m, where j=log 2(m). Said LFSR will be determined by a primitive polynomial A of degree k, which guarantees the path for each of the elements in the list or table of keys in the encryption-decryption process, since 2j=k. The combination of primitive polynomial [A0Ak-1] and filter function [B0−Bj-1] together with the table of keys determines the elements which preferably remain hidden in the encryption system.

To encrypt a piece of data to be sent, said piece of data has to be structured in a hierarchical manner to obtain the secure properties of said code, more particularly the size or length of the packet should be substantially less than the size of the table of keys. For example, if the size of the table of keys is m=1024 words, the packets should not have a size p of more than 512 words. The original message M of any size is firstly broken up into a group of p packets (P0, P1, . . . , Pp-2, Pp-1), each one having a length of I bytes, which correspond to the structures which are encrypted and transmitted independently. At the same time, the packets are divided into b blocks (B0, B1, . . . , Bb-1) of q words in length and of n bits per word.

Subsequently, a header block for each packet Pi is generated, which header block is first of all encrypted and transmitted and contains information relating to a random seed (SL-SH), system signatures (FO-F4), the destination and size of the packet (IG-IU; LO-L4), referred to as transmission control block (TCB). At the end of the packet Pi, following the blocks B0, . . . , Bb-1, which only contain information (corresponding to the message to be encrypted/decrypted), a final block BF is included, which contains both information and bits, of the Checksum type, for checking errors in the transmission (sum of the number of bits or bytes in a transmission, or a file for recognising if any information has been lost or modified).

Once the TCB has been generated, the step of synchronising the emitter begins. In the following, FEED represents the encrypted seed and TCB represents the encryption of the transmission control words, TCB. In addition, the symbols SEED[i], FEED[i], TCB [i], TCB[i] represent the i-ith word of the seed, the encrypted seed, TCB and the encrypted TCB, respectively

A real time clock RTC is used to generate a random number of k bits which are used as a seed or initial state to the LFSR of the non-linear filter generator. The LFSR states are used to produce, by means of the non-linear filter function B, a series of semi-random numbers between 1 and m which indicate the positions in the table of which the contents produce, by means of an XOR operation with each of the TCB words, the encrypted TCB, denoted by TCB, as well as the rest of the words of the unencrypted text message. Next, the seed is divided into words of length n, adding, if necessary, zeros to the left of one of the words and by means of k predetermined TCB bits to be used again as an input for the LFSR, which, by means of the filter function B, again produces a series of positions in the table, the elements of which are XOR-added to the seed words to produce the encryption of the seed. The number of words into which the seed is divided is exactly the same as the integer of k/n. In this way, a first encrypted message which matches TCB is transmitted, the first k bits forming the encryption of the seed that is used for encrypting the message.

The process of encrypting the original message to be sent is exactly the same as that for encrypting the TCB, i.e. the words of the message are XOR-added block by block to the elements of the table, the positions of which are determined by the path descriptor, using the (unencrypted) seed transmitted in the encrypted TCB as the initial state of said descriptor. Once the packet is complete, it is transmitted and the process is repeated with the following packet, i.e. generating a new TCB, seed, etc., and so on successively until all the message packets are complete.

In the particular case of wireless communication systems, ahead of the header block (TCB), synchronism and signature words of the hardware device are transmitted, which words are necessary for the synchronisation between wireless units. The rest of the process is the same as that described above. In the case of wireless communications, since there is a higher likelihood of errors than with communication via cables, forward error correction methods (FEC) are normally used, which create redundancy of information for improving the bit error ratio (BER). In this case, each encrypted block of q words increases its size by r words of redundancy, which words are generated automatically by the FEC algorithm and are transmitted and received in a manner transparent to the source information.

When the receiver receives an encrypted message, said receiver begins its synchronisation step. For this, it takes the k predetermined TCB bits to use them as an input for the LFSR, thus generating a series of positions in the table, the elements of which, XOR-added to the words corresponding to the k first TCB bits, provide the LFSR seed that is used for encrypting the rest of the TCB. Once obtained, said seed is used as an input for the LFSR, which produces, by means of the non-linear filter function B, a series of positions in the table, the elements of which, XOR-added to the rest of the TCB words, provide the original TCB.

Once the TCB has been obtained and the appropriate checks have been made, the step of decrypting the message begins, which step, successively block by block and packet by packet, is completely symmetrical to the encryption step, producing the original message as the output.

To increase the level of security, it is possible to use a time-dependent encryption/decryption. The process for the time-dependent encryption consists in reading the year, month, day, hour, minute, etc. on the RTC, and generating, by means of a logic operation, a time-dependent key of T bits in size, which will be used to modify, by means of XOR operation, the seed, the output of the non-linear filter function B or the source information directly by XOR-operating said information simultaneously with the table of keys and the time-dependent key.

If the length of the table of keys is sufficient and the selection of the descriptor (polynomial A and filter function B which determine the path order of said table of keys) is suitable, the means described provide an increased level of security because, if the table and descriptor are secret, even if the encryption algorithm is known, the only attack possible is by “brute force”, i.e. by trying using all possible tables of keys, path descriptors and seeds. Said attack cannot be carried out using current computers since it is very time-consuming.

In accordance with a specific example, the secured memory, to which the central computing element (the microcontroller) has access, contains a list or table of keys formed by 1024 numbers of 8 bits generated in a random manner. The microcontroller contains, in its EEPROM memory, a 16-stage LFSR (as can be seen, 216 is greater than 1024) and a filter function thereof defined by a function that selects the output of the first 10 stages of the LFSR, thus producing semi-random numbers between 0 and 1023 or, equivalently, between 1 and 1024. Of the 2048 possible 16-stage linear feedback circuits mentioned in the description, use is made of the circuit that is given by the primitive polynomial A=1+x+x2+x8+x13+x15+x16.

e) A Secure Memory Unit

A secure memory unit which is in communication with the processing means and can be encrypted in accordance with the I2C protocol.

f) A Wireless Communication Unit

The communication unit allows for communication between the biometric device and the outside for sending and receiving encrypted information. For example, the wireless communication unit can be a Bluetooth unit, as will be seen below.

In a preferred embodiment, the portable biometric device according to the invention can further comprise a visualisation means, for example an LCD screen, for displaying information to the user.

This novel portable biometric device allows the user to authenticate himself and allows for communication to take place with both an extremely high degree of security and almost absolute certainty that any person who does not have the encryption/decryption unit provided in the processing means of the portable biometric device according to the invention or the biometric data centre means (described below) will not be able to access the transmitted information.

A second aspect of the invention is directed to a secure actuation device designed for allowing a user to control the opening or closing of security elements. To do so, the secure actuation device basically comprises: a communication unit, physical security means, a processing means, a secure memory unit, and actuators. Each of these elements will be described in more detail below:

a) A Communication Unit

The communication unit is used for exchanging encrypted information with the portable biometric device, the encrypted information including biometric data of a user. This information can be exchanged using Bluetooth, for example. In addition, the communication unit has means for communicating over the internet.

b) Physical Security Component

The physical security means comprise a plurality of microswitches that detect possible deformations in an outer shell of the portable biometric device according to the invention as a result of tampering. These microswitches cause an alarm to be triggered if they detect movements, owing to twisting or bending the outer shell, which are not compatible with the normal use of the portable biometric device.

In addition, the outer shell of the portable biometric device can be completely filled with cured epoxy resin, making any tampering of the electronic components therein extremely difficult.

c) A Processor

A processing means designed to decrypt said encrypted information received from the portable biometric device. The encryption/decryption algorithm is similar to the one described above in relation to the portable biometric device.

d) A Secure Memory Unit

A secure memory unit that is in communication with the processing means and can be encrypted in accordance with the I2C protocol.

e) Actuator(s)

One or more actuators for opening or closing external elements in accordance with commands from a user included in the received information. For example, they may be relays or other actuation mechanisms for opening and closing doors, windows or other elements in order to prevent unauthorised persons from accessing any type of installation.

A third aspect of the present invention is directed to a biometric system for secure communication which basically comprises a portable biometric device, a gateway device and an authorised biometric data centre. Each of these elements is described in greater detail below.

a) Portable Biometric Device

A portable biometric device as described earlier in the present document.

b) Gateway Device

The gateway device is any electronic device with internet connectivity. It may, for example, be a laptop computer on which an application has been installed for secure data exchange over the internet using the portable biometric device according to the invention.

The gateway device is in communication with said portable biometric device, and receives encrypted information, which contains biometric data of a user, from the portable biometric device.

c) Authorised-User Biometric Data Centre

A database containing the (biometric) data of the users who are authorised to use the system, and also processing means for encrypting/decrypting incoming and outgoing messages.

Basically, the biometric data centre receives encrypted information, which may contain the biometric data of the user, a unique identifier for the portable biometric device and/or some other form of identification, from the gateway device and checks whether it corresponds to an authorised user.

Optionally, the biometric system for secure communication may also comprise a secure actuation device as described earlier in the present document. The presence of this secure actuation device means that not only can the system improve the security of operations carried out over the internet, but also allows an authorised user to control physical security elements that control access to a facility. This will be described in more detail later in this document.

A fourth aspect of the present invention is directed to a method for operating a system that comprises the portable biometric device, the gateway device and the authorised-user biometric data centre, in order to perform secure operations over the internet with a destination server. This method basically comprises the following steps:
1) The portable biometric device asks a user to identify himself
2) The user inputs his biometric data into the portable biometric device.
3) The portable biometric device encrypts the biometric data and sends a message that includes said data to the biometric data centre via the gateway device.
4) The biometric data centre decrypts the received message, checks whether the biometric data correspond to an authorised user and sends the response to the gateway device.
5) The gateway device grants or denies the user access to the destination server depending on the response received from the biometric data centre.

According to a preferred embodiment of this aspect of the invention, if access is granted, the method also comprises the following steps:
6) Using the gateway device, the user inputs data to be transmitted to the destination server.
7) The portable biometric device encrypts said received data to be transmitted and, together with new biometric data from the user acquired by said portable biometric device, generates an encrypted message which it sends to the biometric data centre via the gateway device.
8) The biometric data centre decrypts the message received, checks again whether the new biometric data correspond to an authorised user and, if so, re-encrypts the data, which are to be transmitted, using an algorithm that corresponds to that used by the destination server, and
9) The biometric data centre sends the data, which are to be transmitted, to the destination server.

Preferably, the step of generating an encrypted message by the portable biometric device comprises including in the message the data to be transmitted, the new biometric data of the user, a time stamp and a packet number.

In another preferred embodiment, the encryption step of the portable biometric device comprises:
generating path sequences, which are variable in time, of a table of randomly generated keys to determine a key which is selected by means of a path descriptor;
generating a random seed for defining an initial state of the path descriptor; and
executing an encryption/decryption algorithm on said seed and said information, which algorithm includes a bitwise XOR operation with said selected key.

In addition, if the system includes a secure actuation device, it will be possible to control security elements for controlling access to installations or facilities. A fifth aspect of the present invention describes the main steps of this method:
1) A user inputs his biometric data in order to identify himself.
2) The portable biometric device sends the secure actuation device an encrypted message which includes both a command for controlling a security element and biometric data of a user.
3) The secure actuation device decrypts the message and checks whether the user is authorised.
4) If the response is affirmative, the secure actuation device acts on the element by means of an actuator.

### BRIEF DESCRIPTION OF THE DRAWINGS

FIG. 1 is a diagram of the most important parts that make up the portable biometric device according to the invention.

FIG. 2 is a diagram of the most important parts that make up the secure actuation device according to the invention.

FIG. 3 is a schematic diagram that includes all the elements of an embodiment of the system for using the biometric device for carrying out operations over the internet.

FIG. 4 is a schematic diagram that includes all the elements of another embodiment of the system for using the biometric device in combination with the secure actuation device for controlling security elements.

### PREFERRED EMBODIMENT OF THE INVENTION

Some general observations are first provided regarding the present system, which build on the disclosures of our previous patent application WO-2012/140291. The system of comprises a number of elements which allow the recognition of the user and can be integrated into any electronic device or system for biological recognition or authentication of a person and subsequent code generation digital representation for environments on-line.

When the system user uses a portable biometric device, the data is encrypted randomly with time and having the feature that this data, in their encrypted form are quite different from the encryption at an earlier time. This encrypted information is valid until the authentication process occurs in the remote data center, where you get an ID representing the user as a single specimen (Primary) and whose data is used to authenticate the user for only a few microseconds, while sufficient to carry out the authentication. After the authentication process, the data set sent from the primary terminal to the data center is unsuitable for re-use.

Thus, the user's primary identity cannot be replaced or reused. Therefore, the user represented by the primary data is really a living person. In other words, a Primary is a biometric identity specimen produced at command by its owner's anatomy and is only valid until approved by independent database gateway. Each same biometric specimen is differently encrypted from the previous and can only give access to its owner once. It can only be used within a predetermined time limit. It is obsolete straight after one use by its owner and any time after a primary is captured. The system will reject a similar (reproduced) encryption. Commands such as: sending, approving, boarding, accessing, allowing, receiving, collecting, paying, entering, checking in, presenting, etc. will make that person legally responsible by a finger swipe. This action creates a biometric specimen from his/her anatomy only valid until verified by an independent database gateway. It is therefore impossible for primaries to be used by other persons. Primary use will stop identity fraud.

For the unambiguous recognition of the user, a number of elements are used together and act in a predetermined manner. There is therefore provided a method for remote recognition of a living being using biometric data from the living being (generated) together with a verification that the living being is alive. The biometric data may be time-limited encrypted. In another aspect, there is provided a device for remote recognition of a living being, comprising: a biometric data sensor, configured to acquire biometric data from the living being; a life detection sensor, configured to verify that the living being providing the biometric data is alive; a processor configured to compare the acquired biometric data with biometric data stored at the device; and a communication interface, configured to send a time-limited encrypted signal on the basis of the comparison by the processor and the verification that the living being is alive by the life detection sensor.

The use of biometric data (representative of a physical characteristic of the living being, preferably a human), together with confirmation, typically by sensor detection that the living being is alive when the biometric data is obtained means that the biometric data is an accurate representation of the living being at the exact moment when the data was acquired. The time-limited encrypted signal prevents the biometric data or a signal indicating recognition of the biometric data remaining valid outside a predefined period of time (typically no more than one of 1 μs, 2 μs, 5 μs, 10 μs, 100 μs, 1 ms, 2 ms, 5 ms, 10 ms, 100 ms, 1 s, 2 s, 5 s, 10 s from the time of generation) Such data is difficult or even impossible to imitate or counterfeit. A copy of such data will not work, due to the restricted validity of the time-limited encryption.

Hence, the method may provide a freshly at-will produced representation specimen, generated electronically by a living being's anatomy. An encrypted signal is thereby provided each time (following life verification checks and/or comparison with the stored data to confirm its authenticity) and the time-limited encryption may mean that this signal is different from any previously generated signal (even with the same input data). This may therefore make the signal impossible to be re-used. This approach may synthesize the primary way that animals remotely recognize the presence of others, for example using scent.

In one embodiment, the device further comprises data storage, storing an identification code. The time-limited encrypted signal may then comprise an indication of the stored identification code. Typically, the identification code is unique to the device. Additionally or alternatively, the device may be configured to store biometric data only in respect of a single living being, for use as the stored biometric data. Thus, transmission of the identification code with time time-limited encryption may therefore be equivalent to transmitting a signal identifying the user. Preferably in this case, the time-limited encrypted signal does not comprise an indication of the acquired biometric data. Hence, it may not be necessary for the biometric data to be transmitted from the device.

In some embodiments, the acquired biometric data comprises a plurality of acquired biometric data items. Then, the processor may be configured to compare the acquired biometric data with stored biometric data by comparing the plurality of acquired biometric data items with one or multiple stored biometric data items. For example, each of the plurality of acquired biometric data items may be compared with a respective (different) stored biometric data item. The stored biometric data (or biometric data items) can be fixed, but they can optionally be changed. For example, the processor may be configured to change the stored biometric data based on the acquired biometric data. In this case, the stored biometric data may be changed following the comparison of the acquired biometric data with the stored biometric data. For example, this may allow the device to cope with natural variation in the biometric data of the living being over time.

The biometric data sensor may comprises one or more of: a fingerprint reader; an iris scanner; and a neural signal scanner. The life detection sensor optionally comprises light emitters and receivers for the near infrared wavelength. A life detection sensor or means, preferably using an algorithm based on artificial neural networks may also or alternatively be provided.

The processor may have a signal processing means that is capable of generating an encrypted signature from an embedded serial number and/or the data received from the biometric sensor and/or life detection sensor (and optionally only these data items) may be used and the subsequent generation of an encrypted data using an encryption algorithm, which may be based on a nonlinear code generator hardware (which may advantageously allow time-limited encryption).

In the preferred embodiment, the device further comprises an anti-tamper component, configured to check for tampering with at least part of the device. The communication interface may be further configured to send the time-limited encrypted signal on the basis of a result of the check for tampering. Optionally, the anti-tamper component comprises one or more of: a plurality of microswitches for detecting torsion device or manipulation of the device; and at least one infrared sensor arranged to detect opening of a housing of the device.

The biometric data sensor, the life detection sensor, the processor and the communication interface may integrated within a sealed housing. In some embodiments, the biometric data sensor, the life detection sensor, the processor and the communication interface are formed on a single integrated circuit. Hence, a single chip may provide all of the functionality of the device, increasing the range of applications for which the device may be used. Also, this may further assist in preventing tampering.

In another aspect, there is provided a method for remote recognition of a living being, comprising: acquiring biometric data from the living being using a device; verifying by the device that the living being providing the biometric data is alive; comparing the acquired biometric data with biometric data stored at the device; and sending a time-limited encrypted signal on the basis of the comparison and the verification that the living being is alive. This method may have optional additional steps corresponding with any features disclosed herein with respect to the device. For example, the device may further store an identification code and optionally, the time-limited encrypted signal comprises an indication of the stored identification code. The method may further comprise checking for tampering with at least part of the device. Then, the step of sending the time-limited encrypted signal may be performed based on a result of the step of checking.

In some embodiments, the method further comprises one or more of: receiving the time-limited encrypted signal at a data center; determining a validity state for the received time-limited encrypted signal; and sending an authorization signal from the data center in response to the step of determining the validity state. The authorization signal may be a time-limited encrypted signal. The step of determining the validity state preferably comprises one or more of: decrypting the received time-limited encrypted signal; checking if a time limitation of the time-limited encrypted signal has expired; and comparing information indicated in the time-limited encrypted signal with identification details stored at the data center. In the preferred embodiment, the method further comprises storing identification details for the living being at the data center prior to receiving the time-limited encrypted signal. This is a form of enrollment, as will be discussed below.

In some embodiments, the method may comprise one or both of: receiving the time-limited encrypted biometric data acquired from the living being; and making a determination by processing the received time-limited encrypted biometric data. The verification that the living being is alive may comprise neural signal data acquired from the living being. Thus, after obtaining the identification signals (numeric vector) representing the user's identity in any digital environment such as the Internet, it is sent to a secured data center which it has the representation system of identities that is formed by a processing and mass storage which perform the necessary comparisons to determine the individual's identity is authentic and therefore know who is uniquely.

It is in this element processing and mass storage where logic resides needed to integrate the system with external entities or data centers. This can be accomplished via a communication protocol designed specifically for this purpose.

The step of making a determination may therefore comprise decrypting the received time-limited encrypted biometric data. The decryption may or may not be used for making a determination, which preferably comprises one or more of: determining a validity state for the received time-limited encrypted biometric data; determining that the received time-limited encrypted biometric data was generated together with a verification that the living being was alive; and comparing data based on the received time-limited encrypted biometric data with database data, in order to recognize the living being. The step of comparing data may use an artificial neural network based algorithm.

The data center is able to authenticate the user from the life and identification signals sent by any device. To do this, it comprises means for decrypting the received message and to generate a second encrypted/unencrypted message. All so that both, the random seed and the message containing the digital information is encrypted/decrypted by the cipher/deciphering in different ways over time unit.

Thus, all information parameters are stored in the data center previously treated by this electronic encryption element making it impossible to access the content from a resident process in the data center without authorization of the encryption electronic device.

In addition, any operator with full permissions to manage the data center can access the information because the electronic external encryption.

The method may be embodied in the form of computer software, programmable logic or other configurable device. A device for remote recognition of a living being, configured to operate in accordance with any such method is also provided. This device may be an acquisition device and/or a recognition server (also referred to as a secure data server herein).

Thus, each and every biometric reading is automatically encrypted differently from previous readings and can only be validated after having been authenticated by the authentication database.

A true representation of the living being is thereby established. Deciphering the primary by hackers would likely take years and bring nothing of value other than a secondary identity of the type discussed above. The validity of the primary only lasts micro-seconds and therefore it can only be used once by its owner and is obsoleted after access is granted. Primaries that have been tampered or interfered with may be rejected and therefore obsolete. This may be achieved by “life detection”, “anti-tampering”, “random encryption” and “known hardware to known hardware communication”. Primaries that are overdue or expired may be rejected and therefore obsolete. Captured primaries may already be obsolete around the time of capture. Rejected and obsolete primaries are of no use to anybody. Therefore only a valid primary may be used by its owner, making identity fraud impossible.

An example of the biometric device (1) according to a particular embodiment of the invention is described below with reference to the accompanying drawings.

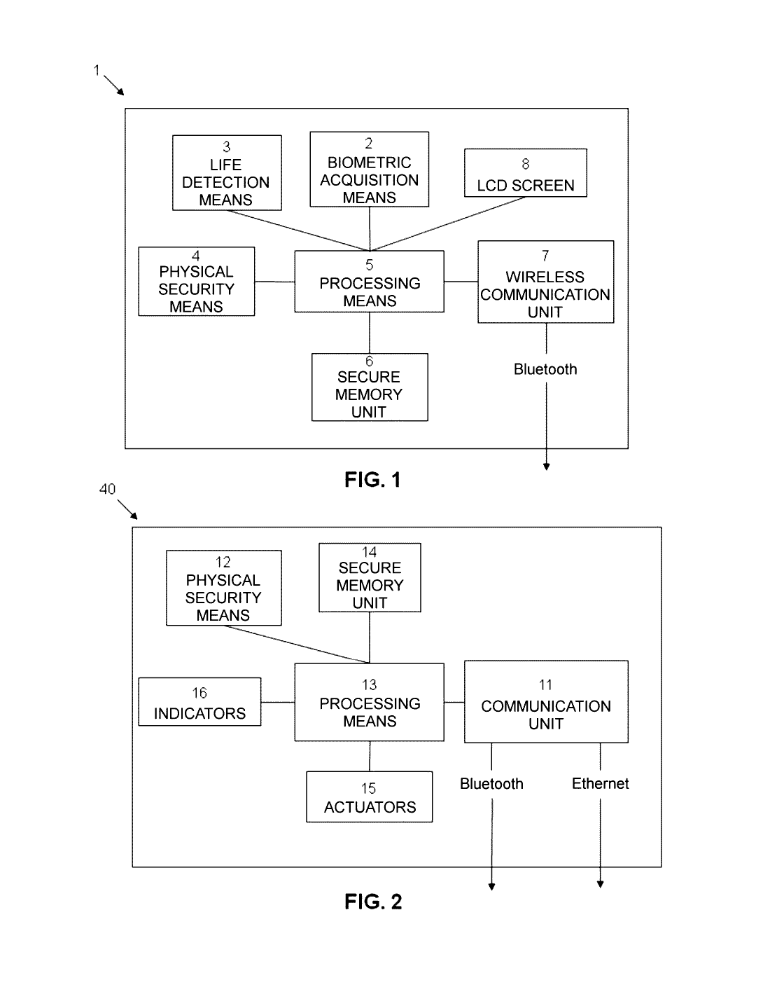

FIG. 1 is a general diagram of an example of the portable biometric device (1) according to the invention illustrating the main elements of which said device is composed. A central processing means (5) encrypts/decrypts the messages exchanged with the outside and controls the general operation of the biometric device (1) according to the invention by communication with a set of ancillary elements designed for each of the particular tasks that said device performs. Specifically, these are biometric acquisition means (2) for acquiring biometric data from a user (normally the fingerprint), life detection means (3) for determining whether the user who is being identified is a living person and is alive (normally a pulse detector and/or a blood oxygen detector and/or a neural sensor), physical security means (4) to prevent the malicious tampering of the portable biometric device (1) by third parties, a secure memory unit (6), a wireless communication unit (7) (normally Bluetooth), and an LCD screen (8).

FIG. 2 is a general diagram of a secure actuation device (10) according to the invention. It can be seen that this secure actuation device (10) comprises a processing means (13) connected to the other elements, which include a communication unit (11) designed to allow both Bluetooth communication with the portable biometric device (1) and internet communication (for example, via an Ethernet network), physical security means (12) to prevent possible physical tampering, a secure memory unit (14), actuators (15), for example relays or the like, for opening/closing the elements to be controlled, and indicators (16) that display the state of said elements.

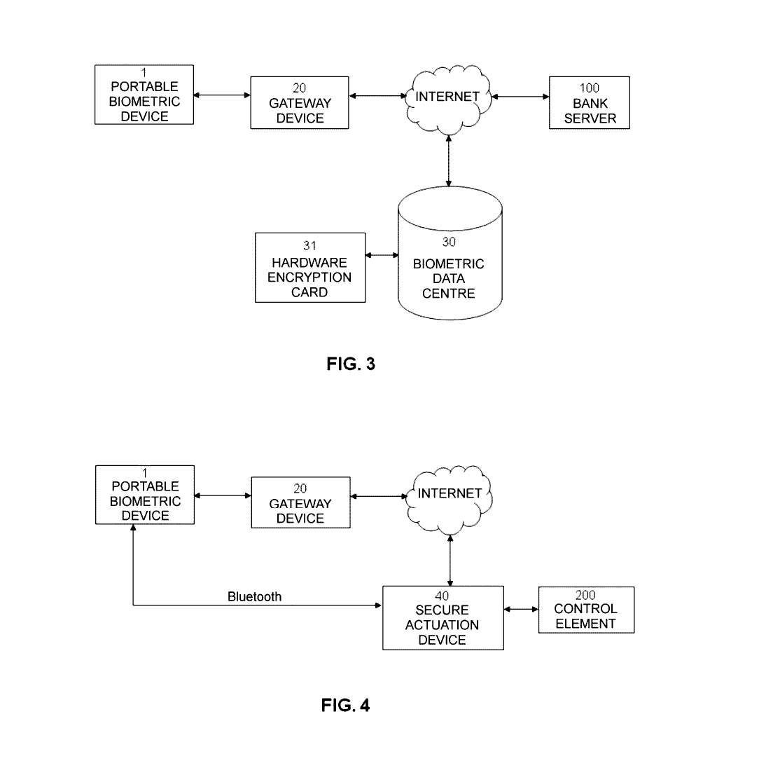

Described below is an example of the use of the portable biometric device (1) according to one aspect of the invention for carrying out secure operations over the internet, such as a banking operation with the exchange of sensitive data with a bank server (100). FIG. 3 shows the main elements of the system used for this purpose. Initially the user is assumed to have the portable biometric device (1) with him. The portable biometric device (1) is therefore preferably in the form of a wristwatch, although other forms such as a key ring, etc. are not excluded. The user also has said gateway device (20), which may be a smartphone, tablet, laptop computer or in general any electronic device with processing capacity and connection to the internet or to an intranet.

To carry out the method, the gateway device (20) must have an application installed for the secure exchange of data using the device (1) according to the invention. When the user accesses this application, a symmetrical key negotiation is established between the portable biometric device (1) and the gateway device (20) in order to secure the physical communication channel, for example Bluetooth or other channel. Other forms of short (or medium) range wireless communication can be used, such as wireless LAN, cellular radio communication, optical communication or modes with similar range.

Once the logical security of this communication channel has been established, the application sends an identification request to the portable biometric device (1) of the user from the gateway device (20) via the secured Bluetooth channel. In response, the portable biometric device (1) asks the user to place his finger in a particular region of the device (1) so that the biometric acquisition means (2) and the life detection means (3) can capture the relevant data.

Depending on these data, the processing means (5) of the portable biometric device (1) determines whether the finger actually relates to a living person. If it does, a message is generated of which the principal elements are the acquired biometric parameters, a time stamp and a packet number. Next, the processing means (5) encrypts this message and sends it to the gateway device (20). The gateway device (20) then sends on the encrypted message over the internet to a biometric data centre (30) where the biometric data of each authorised user corresponding to each portable biometric device (1) are stored.

The biometric data centre (30) checks whether the person who is attempting to access the application is actually the authorised user of that particular portable biometric device (1). If the identification is positive, this is communicated once again over the internet to the application on the gateway device (20), which then unblocks all the application options that the user has contracted to operate at that time using the portable biometric device (1). The user then has the option of carrying out banking transactions, remote access, etc.

All these options are in fact micro-applications within the root application, all contained in the gateway device (20). Each application has a unique international identification number. The user then selects the environment in which he wishes to operate using the portable biometric device (1) and inputs the required data for the operation (for example, a bank transfer) using the gateway device (20). Next, the gateway device (20) sends a message containing these data to the portable biometric device (1) for encryption. Once this has been done, the portable biometric device (1) again asks the user to identify himself using his fingerprint in order to confirm the operation, and generates a message which includes the encrypted data, the biometric data corresponding to the fingerprint of the user, a time stamp and a packet number, all of which are encrypted. This message is returned to the gateway device (20), which in turn sends it on to the biometric data centre (30).

The biometric data centre (30) checks that the user is correctly identified. If he is, it extracts the data for the operation, decrypts them and re-encrypts them, but in this case using the algorithm used by the server which is the final destination of the transaction being performed (bank, government, etc.). Finally, the biometric data centre (30) sends this message containing the encrypted operation data over the internet either directly to the destination server or to the gateway device (20) for retransmission to the destination server.

Finally, the biometric data centre (30) sends an OK message to the gateway device (20), which retransmits it to the portable biometric device (1), which in turn decrypts it and displays it to the user on the LCD screen (8).

More specifically, the data interaction and communication process is as follows, where Ni denotes the control number of the message Mi and the server is a data authentication centre:
i. The communication gateway sends the message M1 to the server with N1 and with, in this example of biometric data, the fingerprint. The fingerprint and the operation are transmitted in this message, all calculated from the portable device.
ii. The server sends M2 to the gateway with N2 and, in the information that follows the header, N1. By means of the portable device, the gateway thus has confirmation of receipt of the fingerprint by an authorised card (that of the server), as it will obtain N1.
iii. The gateway sends M3, which came from the portable device, to the server with N3 and, in the information that follows the header, N2. The server now checks that M1 is not a message that has been repeated within the time window because it obtains N2.
iv. The server performs the matching and sends M4 to the gateway for processing by the portable device with acceptance AC of the operation and with N3 in the information that follows the header. The operation is accepted because the device has recovered N3. The portable device activates the operation acceptance message on its LCD display.

It is therefore the hardware that accepts the operation and circumvents any malware which may exist on the gateway device (20), i.e. a cell phone, laptop computer, etc., and which could falsely state that the operation has been accepted.

However, if a secure actuation device similar to that of FIG. 2 is used, a system similar to that of FIG. 4 is obtained. In this case, the portable biometric device (1) would communicate directly via a wireless connection, such as Bluetooth, with said secure actuation device (40). Then, after activating the portable biometric device (1) in order to connect to the secure actuation device (40), the user is identified locally on the secure actuation device (40), and if the identification is accepted, a message is sent to the secure actuation device (40) consisting of the identification data of the user together with the corresponding time stamps and the packet number. The secure actuation device (40) receives said information, decrypts it and checks in its secure internal memory whether the user has permission to perform the operation concerned. This can also be checked remotely over the internet as the secure actuation device has internet connectivity in order to consult a server about the permissions of the user before actuating an external element via the relay or other actuation mechanism. Once the secure actuation device (40) has completed the operation, the encrypted response is sent to the user. The portable biometric device (1) receives said message via the Bluetooth channel, decrypts it and displays it to the user.

Although one embodiment and mode of operation has now been described, the skilled person will recognise various modification and variations that are possible. For instance, the biometric device (1) may communicate directly with the data center (30) without the need for a gateway device. Moreover, the biometric device (1) need not send biometric data and ways of achieving this are discussed below in respect of an alternative mode of operation.

In a further example, another mode of operation is now described, which may be combined with the first mode in a variety of ways. For example, each of the features described below may be present in the first aspect, in addition or alternatively. The device (1) acquires data from the user in the following way. Firstly, the life detection sensor confirms that the user providing the biometric data is living. Once this has been confirmed, the anti-tampering sensor confirms that no tampering has occurred. If this is also confirmed, the biometric data (for instance, one or more fingerprints) is acquired and this is compared with biometric data previously acquired for the user, which is stored on the device (1).

Biometric data for only one user is preferably stored on the device (1); the device is therefore customized for that user and cannot be used for identification of anyone else, such that there may be a one-to-one mapping between the user and the device. However, a user can have more than one device (1). Devices can be attached to (for example): remote controllers; car fobs; mobile telephones; mobile telephone covers; wrist bands; watches; bracelets; belt buckles; computers; communication cables (such as USB cables); and/or any mobile device.

The biometric data stored on the device (1) may be changed over time, however. For example, fingerprints alter over time. Therefore, the device (1) may be configured to change the biometric data stored for the user, which may be considered a learning process. This change would normally only take place once the biometric data for the user has been confirmed by comparing it with the already stored data. The change may not necessarily be a replacement of the data, but could be the addition of biometric data to that stored or substitution of only part of the stored biometric data.

Typically, one item of biometric data is acquired and this is compared with one or more than one item of stored biometric data. However, embodiments may be considered in which more than one item of biometric data (for example multiple fingerprints, or two or more different types of biometric data, such as at least one fingerprint and at least one iris scan) may be acquired. The comparison of the acquired biometric data with the stored biometric data may then be based on a correlation between the multiple different items of acquired biometric data.

If the biometric data matches the stored biometric data, the following communication process is then carried out with the data center. The device (1) initiates the communication, which preferably takes place via the gateway device (20) and receives key information from the data center (30) in return. This key information is used to determine the random key to use and it also provides a decryption key. The random key is selected from a set of keys embedded in the database at the data center (30). An embedded serial number is stored in the device (1). This is unique to each device. The embedded serial number is encrypted with the selected random key and this starts a time limit for its decryption. The encrypted embedded serial number is then sent to the data center (30).

The data center will only consider signals received from recognized hardware devices. Once a check has been made on the received signal to confirm this, a Primary authenticator at the data center will verify the received embedded serial number. The Primary authenticator stores one or more of: encrypted identities; biometric data; and encrypted serial numbers for each user. Preferably all of these are stored in a linked way. More information can be stored and linked to these data items if required. Although there may be multiple Primary authenticators, the data for a user is stored in only one specific Primary authenticator.

Once the user's data has been verified, the Primary authenticator produces an identity signal, which is the same identity only encrypted differently each time, with a time limit. This identity signal can be decrypted by the server requiring identify authentication, such as a bank, airline, social network or social security. For the identity signal, AES encryption can be used. For enclosed systems, such as cars, houses, vehicles, safes or other storages, the device may be embodied on a signal integrated circuit (a “primary receptor chip”). These are small discs that can be pre-programmed for a single user and which can transfer a authentication signal, for instance to unlock systems.

In many cases, the data center (30) and secure actuation device (40) can be integrated. Thus, the user carries their own portable biometric device (1) which then communicates (directly or via a gateway device (20)) with the integrated data center (30) and secure actuation device (40), which allows or denies the user's actions based on the data received. Examples of devices or terminals (not exhaustive) are cited: security doors, banking terminals, ticketing terminal or other goods or services, etc.

The device (1) can therefore replace a range of identification items, such as passport, identity document, licences (including a driving licence), keys, passwords, or any other personalised document or information item including those listed herein.

1-15. (canceled)

16. A portable biometric device for secure operations, comprising:
a biometric acquisition sensor for acquiring biometric data of a user;
a life detection sensor for determining that the user whose data are being acquired is alive;
a physical security component formed by a plurality of microswitches that detect possible deformations in an outer shell of the portable biometric device as a result of tampering;
a processor which is in communication with the biometric acquisition sensor, the life detection sensor and the physical security detector, and which is designed to encrypt operating data relating to the biometric data of the user, before sending this externally, and to decrypt incoming external information;
a secure memory unit in communication with the processor;
a wireless communication unit to allow for communication between the processor and the outside;
wherein the encryption operation carried out by the processor comprises generating path sequences, which are variable in time, for a table of keys that are generated in a random manner to determine a key selected by means of a path descriptor, generating a random seed for defining an initial state of the path descriptor, and executing an encryption/decryption algorithm on said seed and said information, which algorithm includes a bitwise XOR operation with said selected key.

17. The portable biometric device according to claim 16, wherein the life detection sensor comprises at least one of: a pulse detector; a blood oxygen detector; and a neural sensor.

18. The portable biometric device according to claim 17, wherein the pulse detector and blood oxygen detector comprise:
i) a set of near infrared LEDs and a light-receiving photodiode;
ii) a filtering module having a wavelength of between 0.1 and 20 Hz for eliminating unnecessary noise and to ensure measurements of between 30 and 300 beats per minute;
iii) a signal amplification module having a gain of between 100 and 1000; and
iv) a control and signal conditioning logic.

19. The portable biometric device according to claim 18, wherein the physical security component further comprises the shell of the biometric device being completely filled with cured epoxy resin.

20. The portable biometric device according to claim 18, wherein the secure memory unit is encrypted using the I2C protocol.

21. The portable biometric device according to claim 18, further comprising a visualization component for displaying information to the user.

22. The portable biometric device according to claim 18, wherein the portable biometric device takes the form of a wrist watch.

23. The portable biometric device according to claim 18, wherein the portable biometric device takes the form of a key ring.

24. A secure actuation device designed to communicate with a portable biometric device so as to allow a user to control the opening or closing of security elements, said secure actuation device comprising:
a communication unit for exchanging encrypted information with the portable biometric device, the encrypted information including biometric data of a user;
a physical security component formed by a plurality of microswitches that detect possible deformations in an outer shell of the secure actuation device as a result of tampering;
a processor configured to decrypt said encrypted information received from the portable biometric device;
a secure memory unit in communication with the processing means; and
at least one actuator for opening and closing external elements in accordance with a command from a user that is included in the received information.

25. A biometric system for secure communication, comprising:
i) a portable biometric device, comprising:
a biometric acquisition sensor for acquiring biometric data of a user;
a life detection sensor for determining that the user whose data are being acquired is alive;
a physical security component formed by a plurality of microswitches that detect possible deformations in an outer shell of the portable biometric device as a result of tampering;
a processor which is in communication with the biometric acquisition sensor, the life detection sensor and the physical security detector, and which is designed to encrypt operating data relating to the biometric data of the user, before sending this externally, and to decrypt incoming external information;
a secure memory unit in communication with the processor;
a wireless communication unit to allow for communication between the processor and the outside;
wherein the encryption operation carried out by the processor comprises generating path sequences, which are variable in time, for a table of keys that are generated in a random manner to determine a key selected by means of a path descriptor, generating a random seed for defining an initial state of the path descriptor, and executing an encryption/decryption algorithm on said seed and said information, which algorithm includes a bitwise XOR operation with said selected key; and
ii) a gateway device in communication with said portable biometric device, which receives, from the portable biometric device, encrypted information containing biometric data of a user; and
iii) an authorized-user biometric data center which receives, from the gateway device, the encrypted information containing the biometric data of the user and which checks whether said data corresponds to an authorized user.

26. The biometric system for secure communication according to claim 25, further comprising a secure actuation device designed to communicate with a portable biometric device so as to allow a user to control the opening or closing of security elements, said secure actuation device comprising:
a communication unit for exchanging encrypted information with the portable biometric device, the encrypted information including biometric data of a user;
a physical security component formed by a plurality of microswitches that detect possible deformations in an outer shell of the secure actuation device as a result of tampering;
a processor configured to decrypt said encrypted information received from the portable biometric device;
a secure memory unit in communication with the processing means; and
at least one actuator for opening and closing external elements in accordance with a command from a user that is included in the received information.

27. A method for operating a system to carry out secure operations over the internet with a destination server, comprising:
a portable biometric device asking a user to identify himself;
the user inputting his biometric data into the portable biometric device;
a portable biometric device sending an encrypted message, which includes identification data, to the biometric data center via a gateway device;
the biometric data center decrypting the received message, checking whether the identification data corresponds to an authorized user, and sending the response to the gateway device; and
the gateway device granting or denying the user access to the destination server depending on the response received from the biometric data center.

28. The method according to claim 27, which, if access is granted, further comprises the following steps:
using the gateway device, the user inputting data to be transmitted to the destination server;
the portable biometric device encrypting said received data to be transmitted and, together with the identification data, generating an encrypted message which it sends to the biometric data center via the gateway device;
the biometric data center decrypting the received message, checking again whether the identification data corresponds to an authorized user, and, if so, re-encrypting the data, which are to be transmitted, according to an algorithm corresponding to that used by the destination server; and
the biometric data center sending the data, which is to be transmitted, to the destination server.

29. The method according to claim 28, wherein the step of generating an encrypted message by the portable biometric device comprises including in the message the data to be transmitted, the new biometric data of the user, a time stamp, and a packet number.

30. The method according to claim 28, wherein the step of generating an encrypted message by the portable biometric device comprises:
generating path sequences, which are variable in time, of a table of keys which are generated in a random manner to determine a key selected by means of a path descriptor;
generating a random seed for defining an initial state of the path descriptor; and
executing an encryption/decryption algorithm on said seed and said information, which algorithm includes a bitwise XOR operation with said selected key.

31. A method for operating a system for controlling a security element, comprising:
a user inputting his biometric data in order to identify himself;
a portable biometric device sending to a secure actuation device an encrypted message which includes a control command for a security element;
the secure actuation device decrypting the message and checking whether the user is authorized; and
if the response is affirmative, the secure actuation device acting on the element by means of an actuator.
